(19) United States
(12) Patent Application Publication
(10) Pub. No.: US 2025/0229521 A1
(43) Pub. Date: Jul. 17, 2025

(54) METHOD FOR INSPECTING A PRINT IMAGE IN A PRINTING PROCESS

(71) Applicant: BST GmbH, Bielefeld (DE)

(72) Inventors: Christian Lohmeier, Bielefeld (DE); Oliver Van Pels, Bielefeld (DE); Ulrich Kohl, Bielefeld (DE)

(21) Appl. No.: 18/701,684

(22) PCT Filed: Oct. 20, 2022
(86) PCT No.: PCT/EP2022/079180

§ 371 Date: Apr. 16, 2024

(30) Foreign Application Priority Data
Oct. 25, 2021 (EP) 21204388.9

(51) Int. Cl. B41F 33/00; G06T 7/00; G06T 7/33

(52) U.S. Cl. CPC B41F 33/0036; G06T 7/001; G06T 7/33; G06T 2207/10008; G06T 2207/30144

(57) ABSTRACT

A method for inspecting a print image in a digital printing process, with image data from images to be printed being available in a pre-printing stage in the form of a digital proof, includes the steps of generating a reference image representing the desired printing result; recording digital live images of printed images; comparing the live images with the reference image; before the print process, searching the digital proof for distinct points in the image to be printed, selecting such points as reference points and determining coordinates thereof, and rendering and saving the digital proof as a reference image; and after printing has started, for each live image, finding the reference points in the live image, calculating a coordinate transformation which converts the reference points of the live image and reference image into one another and comparing the live image with the reference image after applying the coordinate transformation.

The invention relates to a method for inspecting a print image in a digital printing process, in which image data from images to be printed are available in a pre-printing stage in the form of a digital proof, the method comprising the steps of:
generating a reference image which represents the desired printing result,
recording digital live images of printed images, and
comparing the live images with the reference image.

An inspection method of this type aims at the early detection of defects in the printing process, so that, when a defect occurs, the printing process may be aborted or other countermeasures may be taken before a large amount of waste has been produced. EP 2 700 505 B1 discloses a method of inspecting images that have been printed in a rotary printing process, wherein the reference image is obtained by capturing digital images of formats that have been printed onto the web of print medium in the run-up phase at the beginning of the printing process and then electronically superposing a certain number of these digital images, thereby to obtain, as reference image, an averaged image showing lesser statistical fluctuations than an individual live image. In this method, in order to minimize the production of waste, one of the live images that has been used for calculating the reference image is already compared with the digital proof that specifies the desired print result. In this way, substantial deviations can already be detected at a very early stage, before a sufficient number of live images for generation the reference image are available.

This inspection method would be applicable also to a digital printing process in the same form.

It is an object of the invention to provide a method by which the production of waste can be reduced further.

According to the invention, this object is achieved by a method having the followings steps: before the start of the print process:
searching the digital proof for distinct points in the image to be printed;
selecting a number of such points as reference points and determining coordinates of the reference points in a proof coordinate system;
rendering the digital proof and saving the rendered image as a reference image; after printing has started, for each live image:
finding the reference points in the live image;
calculating a coordinate transformation which converts the reference points of the live image and the reference image into one another; and
comparing the live image with the reference image after applying the coordinate transformation.

Thus, in the method according to the invention, the reference image is generated already at a point in time before the start of the printing process, before even a first printed image of which a live image could be captured is available. Thus, the inspection by comparing the print results with a high-quality reference image can practically start already with the first printed image.

In practice, however, the problem is that certain image distortions may occur during the printing process, due to, for example, inaccuracies in the web guiding system, tension-dependent expansion of the media material, and the like. The distortions have the effect that each live image differs slightly from the reference image, so that a direct comparison is not possible or would result in rejecting each printed image as defective. In the method according to the invention, these distortions are compensated computationally by selecting, in the image to be printed, already before the print process has started, certain reference points that are distinctly eminent and easy to locate. Then, during the print process, the same reference points are also selected in each live image, so that it is possible to detect the distortions by comparing the positions of the reference points in the proof to those in the live image, and to correct the distortions by a suitable coordinate transformation. In this way, each live image is matched with the reference image on its entire surface, so that all deviations that then still remain hint to true errors in the print process. Ideally, when the printed image is completely free of defects, an image without any image content should be obtained when, after the removal of the distortions, the live image is digitally subtracted from the reference image.

The correction of distortions can be achieved either by applying a coordinate transformation to the live image and comparing the transformed live image with the reference image or by applying an inverse coordinate transformation to the reference image and then comparing the transformed reference image to the respective live image.

The coordinate transformation that is necessary for the rectification of distortions can be performed very quickly by means of specialized graphics processors as they are used also for computer games. The time-consuming calculations that are necessary for rendering the reference image and for a careful selection of the reference points in the digital proof are performed already before the print process has started, so that the productivity of the print process is not compromised thereby, all the more since these preparatory calculations can be performed already while a preceding print process is running on the print engine.

An embodiment example will now be explained in conjunction with the drawings, wherein:

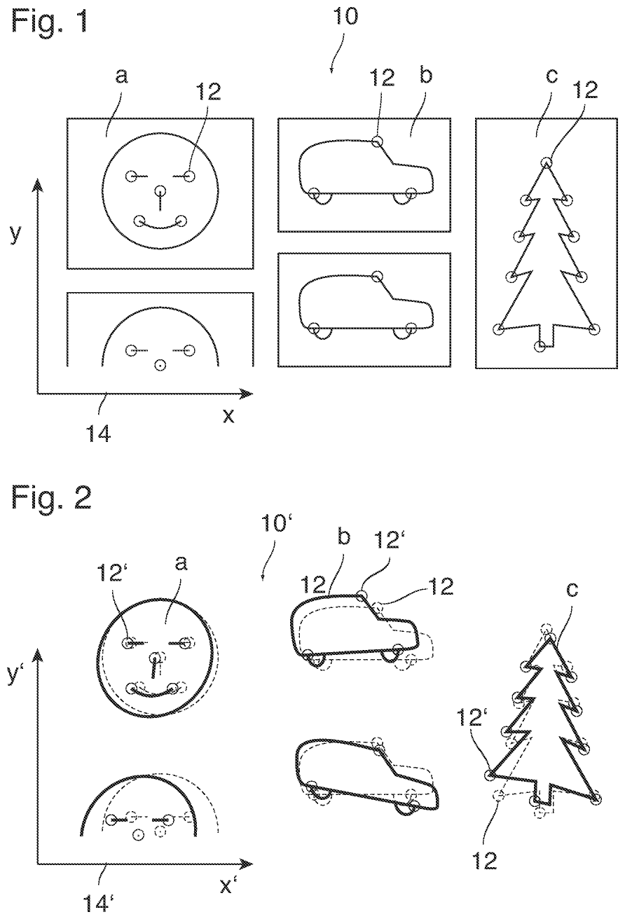

FIG. 1 is a schematic view of a digital proof for a desired print product;

FIG. 2 an exaggerated graphical representation of distortions of a printed image;

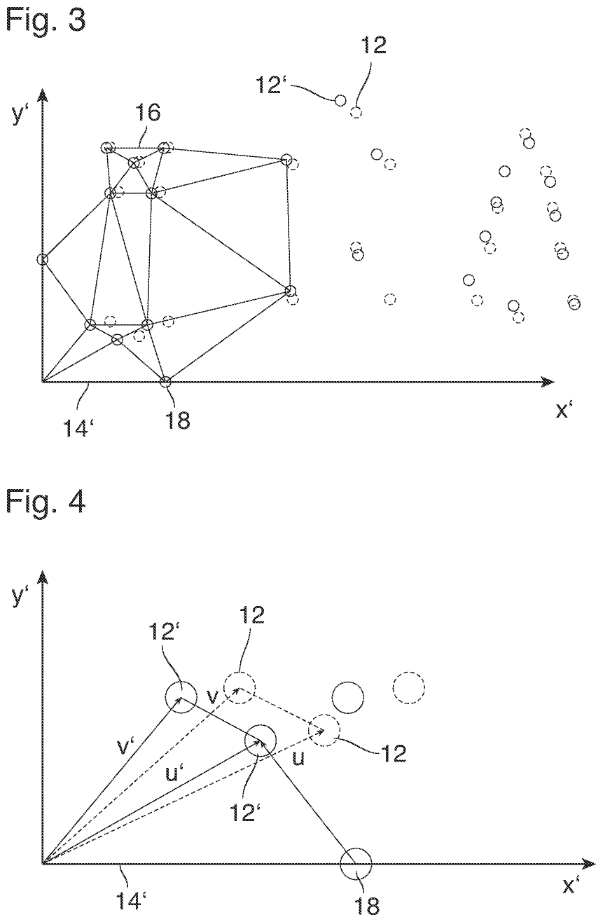

FIG. 3 a grid of reference points of the digital proof, superposed with corresponding reference points of a distorted live image;

FIG. 4 an enlarged detail of FIG. 3;

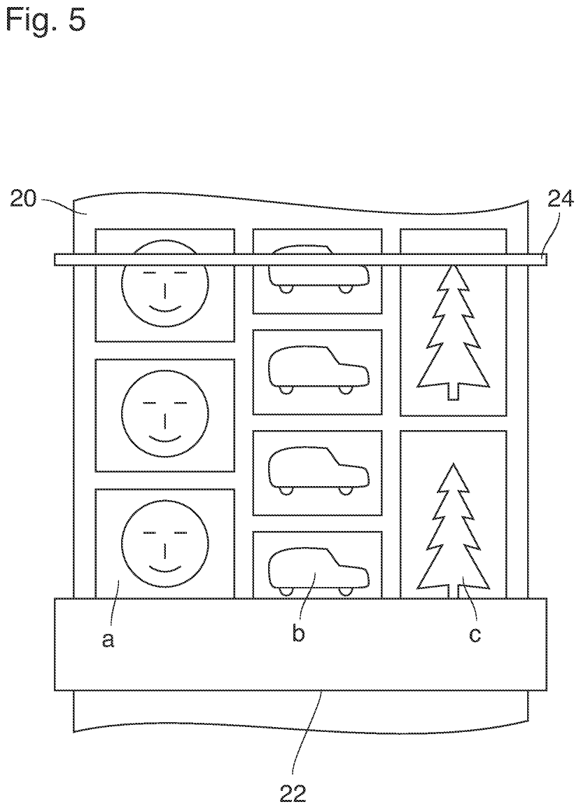

FIG. 5 a schematic view of a portion of a printed media web; and

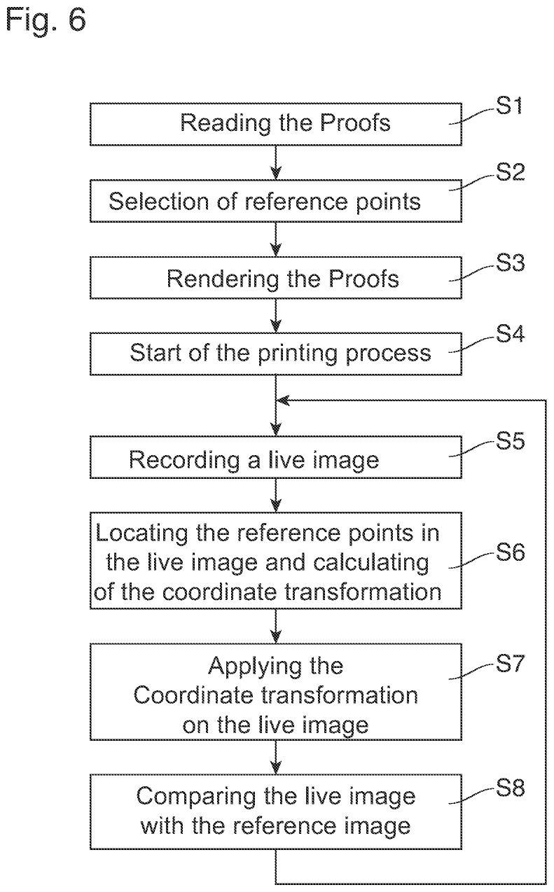

FIG. 6 a flow diagram illustrating the method according to the invention.

FIG. 1 schematically shows a digital proof 10 that serves as a template for a print product in the form of an endless printed web. The proof is not a rastered image but a data file in a standardized format, such as PDF, which contains the image information in compressed form. For the print process, the proof has to be rendered, i.e. converted, by raster image processing, into an image format (bitmap) in which the image information for each pixel is given by digital density and/or color values that may then directly be used as control signals for the printing elements in a digital printer such as a high-production ink jet printer.

In the example shown, the proof 10 includes three different motives a, b and c, that are to be printed onto the media web in three parallel tracks. The motives differ from one another in their repeat, i.e. in their length in running direction of the media web. In the example shown, the proof 10 defines a printed image the width of which corresponds to the width of the media web and the length of which corresponds to the repeat of the longest motif c. In this printed image, the motif b is contained in two complete copies, whereas the motif a is contained in only one complete copy and again as an incomplete copy. Then, for printing an adjoining section of the media web, another proof is needed which contains among others the part of the second copy of the motif a that is missing in FIG. 1. In principle, when the repeats of the motives a, b and c are not in a rational ratio (that is expressible by small integral numbers), a different proof is needed for each section of the media web. In practice, it will therefore generally be attempted to arrange the motives such that the proof contains only complete motives the arrangement of which is repeated periodically, so that only a single proof needs to be rendered for the entire print process.

FIG. 2 shows a so-called live image 10′, i.e. a digital copy of the image that has been printed onto the media web. In the physical print process, certain image distortions will inventibly occur, so that the appearance of the printed motives will slightly differ from the appearance of the motives in the proof, as has been shown exaggeratedly in FIG. 2. If the quality of the print product is to be checked by means of an electronic inspection method, a reference image is needed that has the same distortions as the printed image. Only then will it be possible to electronically compare the live image that represents the image actually printed to the reference image by subtracting the image information of the reference image from the live image so that only any possible deviations will be visible in the difference image.

In the method that is being proposed here, the reference image is obtained from the digital proof 10, and the image distortions are accounted for by rectifying the live image before comparing it to the reference image. To that end, certain reference points 12 are selected in the digital proof 10 already before the print process has started. These reference points are eminent points in the printed motives that can easily be located, for example, acute corners or crossing points or end points or starting points of high-contrast image contours. Ideally, the reference points 12 should define a kind of grid that is spread over the entire area of the image to be printed. The density of the reference points may depend on the structure-richness of the image, so that, for example in image areas that are uniform and poor in structure, a coarser raster can be used than in highly structured image zones. Then, when a live image of the printed web has been captured, e.g. the image shown in FIG. 2, reference points 12′ are identified in this live image by digital image processing, these reference points 12′ corresponding to the reference points 12 in the proof but having positions that are slightly different from the positions of the reference points 12 due to the image distortions. Then, on the basis of these deviations, a coordinate transformation is calculated that returns the reference points 12′ to their original positions. The same coordinate transformation is applied to all the pixels of the live image, so that the image is rectified and the motives a, b and c regain their original shape and can then be compared to the reference image, i.e. the rendered proof.

The selection and definition of the reference points 12 in the proof 10 is performed electronically by means of an algorithm that analyses the image information in the proof. The coordinates (x, y) of each reference point in a proof coordinate system 14 (FIG. 1) are measured and stored. Supplementarily, a little image file that shows the immediate environment of the reference point may be stored for each reference point.

In the live image 10′, a live image coordinate system 14′ as been defined such that, in a non-distorted image, all reference points would have the same coordinates as in the proof. Since the amount of image distortion will generally be small, the known coordinates (x, y) in the proof will make it possible to narrow the search region within which the corresponding reference point must be searched for the live image 10′. The exact localization of the reference point and the determination of its coordinates (x′, y′) in the live image coordinate system 14′ is then achieved by comparing the environment image file of the reference point to the image content of the live image.

In FIG. 3, the reference points 12′ found in the live image are shown in continuous lines and the corresponding reference points 12 (transferred into the live image coordinate system 14′) are shown in dashed lines. For calculating the coordinate transformation for rectifying the image, all reference points 12′ in the live image are connected by a grid 16 that is composed of triangular area elements. Only a part of this grid has been shown in FIG. 3. Additional auxiliary points 18 have been defined on the edge of the image so that the entire surface area of the image can completely be tessellated with the triangular area elements of the grid.

The coordinate transformation is calculated separately for each of these triangular elements. In FIG. 4, this has been exemplified for a triangular surface area the corners of which are the origin of the live image coordinate system 14′ and two reference points 12′. The position vectors of the two reference points 12′ are designated as u′ and v′. The position vectors u and v of the corresponding reference points 12 in the proof have been shown in dashed lines. Now, the vectors u and v can be expressed a linear combination of the vectors u′ and v′:

$$u = {t}_{1 , 1} {u}^{′} + {t}_{1 , 2} {v}^{′}$$

$$v = {t}_{2 , 1} {u}^{′} + {t}_{2 , 2} {v}^{′}$$

The coordinates t_{1,1}, t_{1,2}, . . . form a 2×2 matrix T that defines the coordinate transformation for this triangle. In order to rectify the part of the image contained in this triangular area element, the coordinate transformation is applied to each pixel in this area element, i.e. the position vector of each pixel is multiplied with the matrix T.

The same procedure is applied to each of the triangular area elements of the grid 16 that is defined by the reference points 12′. In the image that is obtained by these transformations, the locations of all reference points are exactly identical with the locations of the original reference points in the proof. For the rest of the contents of the image, this coincidence is only approximate because, in general, the image distortions will be non-linear and the coordinate transformation that has been used here is piece-wise linear (i.e., linear in each area element). However, the coincidence will be improved with decreasing mesh size of the grid 16.

FIG. 5 shows a section of a media web 20 running underneath and past an inkjet print head 22 that extends over the entire width of the web and with which the motives a, b and c are continually printed onto the media web. Further downstream, a line camera 24 is arranged above the media web, for sequentially capturing live images that correspond to the size of the proof 10 and, after rectification, are compared to the corresponding reference images.

The essential steps of the inspection method have been shown in a flow diagram in FIG. 6. In step S1, the digital proof 10 is read. In step S2, the reference points 12 are selected. In step S3, the proof is rendered in order to generate the reference image. Only then will the print process be started in step S4. Thus, the steps S2 and S3 that consume a lot of time and computation power are completed already at the start of the print process and may, for example, be carried out at time during which the inkjet print head 22 is still busy with another print job.

As soon as the inkjet print head 22 has printed a first image of the size of the proof 10, the first live image is captured with the line camera 24 in step S5. In step S6, the reference points 12′ are identified in the live image, and the coordinate transformation for the rectification of the image is calculated (calculating the matrices T for all triangular area elements). In step S7, the coordinate transformation is applied to the entire live image, and, finally, the result of this transformation is compared to the reference image in step S8. Then, the process returns to step S5 where the next live image is captured. The steps S5-S8 are repeated cyclically, wherein, due to the arrangement of the motives shown in FIG. 1, a different reference image must be used in each cycle. However, the selection of the reference points and the calculation of the reference images for these additional proofs is requiring less computing power because it may be based on the results that have been obtained for the first proof. The steps corresponding to the steps S1, S2 and S3 for each subsequent proof may therefore optionally be performed also while the print process is running, timely enough for the results to be available when the corresponding live image is captured.

What is claimed is:

1. A method for inspecting a print image in a digital printing process, in which image data from images to be printed are available in a pre-printing stage in the form of a digital proof, the method comprising the steps of:
generating a reference image which represents a desired printing result as the digital proof;
recording digital live images of printed images; and
comparing the live images with the reference image;
before the start of the print process:
searching the digital proof for distinct points in the image to be printed;
selecting a number of such points as reference points and determining coordinates of the reference points in a proof coordinate system; and
rendering the digital proof and saving the rendered image as a reference image;
after printing has started, for each live image:
finding the reference points in the live image;
calculating a coordinate transformation which converts the reference points of the live image and the reference image into one another; and
comparing the live image with the reference image after applying the coordinate transformation.

2. The method according to claim 1, wherein the coordinate transformation is a piece-wise linear transformation.

3. The method according to claim 1, wherein the coordinate transformation is applied to the live image and the result of the transformation is compared to the reference image.

4. The method according to claim 1, wherein the proof includes a plurality of motives that are to be printed onto a media web in several parallel tracks.

5. The method according to claim 4, wherein the poof includes image information for an image area that extends over the entire width of the media web.

6. The method according to claim 4, wherein the motives differ in their repeat and are arranged in the image area such that the proof contains at least one complete copy of each motif.

7. The method according to claim 6, wherein the image content of the proof represents a section of the media web carrying a printed image that is repeated periodically.
